(19) United States
(12) Patent Application Publication
(10) Pub. No.: US 2026/0009293 A1
(43) Pub. Date: Jan. 8, 2026

(54) SPECIAL UNDERGROUND CONSTRUCTION DEVICE AND METHOD FOR OPERATION OF A SPECIAL UNDERGROUND CONSTRUCTION DEVICE

(71) Applicant: ABI Anlagentechnik-Baumaschinen-Industriebedarf Maschinenfabrik und Vertriebsgesellschaft mbH, Niedernberg (DE)

(72) Inventors: Albrecht KLEIBL, Grosshennersdorf (DE); Christian HEICHEL, Niedernberg (DE)

(73) Assignee: ABI Anlagentechnik-Baumaschinen-Industriebedarf Maschinenfabrik und Vertriebsgesellschaft mbH, Niedernberg (DE)

(21) Appl. No.: 19/252,228

(22) Filed: Jun. 27, 2025

(30) Foreign Application Priority Data
Jul. 3, 2024 (EP) 24186354.7

(51) Int. Cl. E21B 7/02

(52) U.S. Cl. CPC E21B 7/022

(57) ABSTRACT

A special underground construction device, in particular pile-driving or drilling device, includes a support frame, on which a holder for a hydraulic working device is arranged, as well as two hydraulic main pumps for making available at least one hydraulic oil volume stream for operation of a held working device, which pumps are connected to the holder by way of lines, wherein a first one of the hydraulic main pumps is driven by a first motor connected to it, and the second of the hydraulic main pumps is driven by a separate, second motor connected to it. Furthermore, a method operates such a special underground construction device.

### CROSS REFERENCE TO RELATED APPLICATIONS

Applicant claims priority under 35 U.S.C. § 119 of European Application No. 24186354.7 filed Jul. 3, 2024, the disclosure of which is incorporated by reference.

### BACKGROUND OF THE INVENTION

### 1. Field of the Invention

The invention relates to a special underground construction device, in particular a pile-driving or drilling device, comprising a support frame on which a holder for a hydraulic working device is arranged. The invention furthermore relates to a method for operation of a special underground construction device, in particular a pile-driving or drilling device having a hydraulic working device.

### 2. Description of the Related Art

Special underground construction machines such as pile-driving or drilling devices are mobile working machines, and diesel engines are regularly used to drive them. Hydraulic pumps are driven by way of the diesel engine of the support frame, which pumps drive the hydraulic motors of the working device, for example of a pile-driving or drilling device, by way of a hydraulic circuit. The special underground construction devices are operated with different working devices. The transfer of power takes place hydraulically. If the special underground construction device has a support frame having a chassis, then this chassis is driven, just like the working devices, by the oil volume streams of these hydraulic pumps.

Not only working devices that are operated with a single hydraulic volume stream but also those working devices that require two hydraulic volume streams that are independent of one another, for example so as to drive a drill pipe and a drill screw independently of one another, are used. For this reason, usually two main pumps are installed in special underground construction devices, which pumps allow volume streams that can be regulated independently of one another and can be combined if needed. Furthermore, usually the crawler track units are also operated by way of the main pumps. Because the special underground construction devices travel on two crawler tracks, and it must be possible to drive the chassis independently of one another, it is practical to also provide two main pumps for this purpose.

In the case of those working devices that are operated with only one working circuit, in other words with only one hydraulic volume stream, such as, for example, vibrators or Kelly drilling drives, the volume streams of the main pumps are added together. This addition takes place by way of hydraulic valves or by way of a hydraulic connection of the two hydraulic circuits of the two main pumps. The two main pumps are usually variable-displacement pumps, the displacement of which is variable and can be regulated all the way down to zero. In larger machines, additional main pumps are also used, which can make an additional volume stream available, which stream can be added to one of the two independent volume streams or to the combined volume stream. In most cases, four working lines are installed from the hydraulic assembly to the working device. These four working lines comprise two forward lines and two return lines, and allow for two independent circuits.

The two main pumps are usually driven by the diesel engine by way of a pump transfer gear. The drive can also take place directly, so that both pumps are directly connected to the crankshaft. Because of the mechanical coupling, the two main pumps rotate at the same speed. The required volume streams are produced by means of varying the displacements of the main pumps.

The energy losses in the main pumps are significant. Modern variable-displacement pumps do reach degrees of effectiveness of almost 90%, but only under optimal conditions. In the case of reduced displacement, disadvantageous pressure conditions, and a low rotating speed, the degree of effectiveness of the pump can drop to below 70%. In idle, at displacement zero, the driving power values for spinning the main pumps can amount to several kW. These power values are referred to as drag power or drag losses, and always occur if no hydraulic power is needed at the working device, but the diesel engine is not turned off. To avoid such power losses, it is proposed, in EP 2 546 420 A2, to provide a clutch by way of which the motor shaft can be separated from the main pumps.

In the case of operating states that require only small oil volume streams, the degrees of effectiveness of the pumps are particularly poor, because both the reduction in the displacement of the main pumps and also very low pump rotating speeds reduce the degree of effectiveness. If small volume streams are needed in the case of working devices that are not dependent on separate volume streams, the main pumps are controlled in parallel. Control in parallel means that both pumps are operated at the same displacement. It is true that in individual situations, energy could be saved by means of asymmetrical control of the main pumps. Because one of the main pumps would rotate in idle when this asymmetrical control happens, however, drag losses would again occur here, and thereby the saved energy would be used up to a great extent.

At this point, it is proposed, in EP 2 557 233 A1, to provide hydraulic motors having variable displacement on the working device, and to reduce the volume stream as well as the displacement of the hydraulic motors of the working device at low power requirements. In this regard, two possibilities are indicated for reducing the volume stream, namely reducing the displacements of the main pumps as well as reducing the rotating speed of the main pumps, which is directly dependent on the rotating speed of the diesel engine. It has been shown that in this way, the hydraulic losses that unavoidably occur during the transfer of hydraulic power can be clearly reduced. Here, too, however, the poor degree of effectiveness of the pumps, at a low pump displacement and a low pump rotating speed, proves to be disadvantageous.

Poor degrees of effectiveness of the pump or drag losses require a drive power that brings about an energy consumption that will possibly be missing at the working device and that heats up the hydraulic oil, which must be cooled accordingly. For cooling of the hydraulic oil, coolers are regularly used, which cool the hydraulic oil with ambient air and are equipped with fans, the motors of which in turn consume energy, so as to discharge the heat from the hydraulic oil into the environment.

### SUMMARY OF THE INVENTION

Against this background, the present invention takes its start. The invention is based on the task of making available a special underground construction device, in particular a pile-driving or drilling device, which has a higher degree of effectiveness, in particular at lower power called for by a working device that is provided. This task is accomplished by means of a special underground construction device having the characteristics according to one aspect of the invention.

With the invention, a special underground construction device, in particular a pile-driving or drilling device, can be made available, which has a higher degree of effectiveness, in particular at lower power called for by a working device that is provided. Because the two hydraulic main pumps are each driven by way of their own drive motor, in other words, a first one of the hydraulic main pumps is driven by a first motor connected to it, and the second of the hydraulic pumps is driven by a separate second motor connected to it, complete shut-off of one of the two main pumps is made possible, and thereby its drag losses are eliminated. Preferably, the support frame has a chassis, which, just like the working device, is driven by at least one hydraulic motor, which is supplied with the hydraulic oil volume stream of the two hydraulic main pumps.

It is advantageous if the support frame has a leader on which a working device carriage is displaceably arranged, which carriage has the holder for a working device.

As compared to the state of the art, it is essential to the invention that the drive of the hydraulic main pumps is completely uncoupled from one another, which pumps can therefore be controlled independently of one another, and thereby operation of the hydraulic main pumps in a range with a high degree of effectiveness is made possible at every call for power by a working device. At a low call for power, one hydraulic main pump can therefore also be shut off, so as to achieve operation of the other hydraulic main pump in a range with a high degree of effectiveness.

In a further development of the invention, at least one hydraulic secondary pump is also provided, to make available at least one hydraulic oil volume stream for operation of secondary assemblies, for example for advancement of the working device, which is implemented by way of winches or hydraulic cylinders, for kinematics, for rotation of the superstructure or for drive of the fans. In this way, a separate supply to secondary assemblies, independent of the hydraulic main pumps, is achieved. Preferably, at least one hydraulic secondary pump is driven by a separate third motor, in particular an electric motor. It can also be practical to bring multiple pumps, but not all of them, together into groups, and to drive them jointly.

In an embodiment of the invention, the first hydraulic pump, the second hydraulic main pump, or both, are configured as a fixed-displacement pump, the pump outlet of which is preferably provided with a kick-back valve. In this way, a more compact method of construction is achieved. Furthermore, fixed-displacement pumps are more cost-advantageous and work more efficiently in many situations. By means of the kick-back valve, reverse drive of the hydraulic main pump that has been shut off, by means of the pressure that the other hydraulic main pump builds up in the oil, is prevented.

In a further embodiment of the invention, the first hydraulic pump, the second hydraulic pump, or both, have a variable displacement. In this way, not only setting the rotating speed but also further setting of the volume stream is made possible.

In a further development of the invention, the first motor and the second motor are connected to a control unit, by way of which they can be controlled independently of one another, wherein the first motor, the second motor, or both, are formed by an electric motor. In this way, more efficient direct drive of the hydraulic main pumps is achieved, which can be separately and simultaneously controlled by way of the control unit.

In an embodiment of the invention, the at least one hydraulic secondary pump is driven by way of a separate, third motor, which is preferably formed by an electric motor. It is advantageous if multiple hydraulic secondary pumps are provided, which are combined into at least two groups, of which at least one group is driven by way of a common motor, preferably an electric motor.

To supply energy to electric motors provided to drive a main pump and/or a secondary pump, an internal combustion engine, preferably a diesel engine can be provided, which drives a generator. Preferably a backup rechargeable battery can be provided, which is electrically positioned between the generator and the electric motors. Alternatively or additionally, a grid connection and/or a sufficiently dimensioned rechargeable battery can also be provided to supply energy.

If two hydraulic main pumps having variable displacement are driven by an electric motor, in each instance, in parallel, as many small volume streams as desired can be implemented. Rotating speed, displacement, and number of driven hydraulic main pumps can be varied. By means of shutting off one pump, the other pump can be operated at a greater displacement or higher rotating speed or a combination of the two variables. At small volume streams, in this way a clearly greater total degree of effectiveness can be achieved.

The degree of effectiveness of electric motors decreases at very small rotating speeds, so that the total degree of effectiveness is increased when one hydraulic main pump is shut off, not only due to the degree of effectiveness of the other hydraulic main pump, which is higher then, but also possibly due to the higher degree of effectiveness of the electric motor. The hydraulic main pump that has been shut down can be set to zero conveying volume. As a result, there is also no risk that it will be rotated in reverse by the oil pressure at the pump outlet. Additional kick-back valves, as in the case of fixed-displacement pumps, are therefore not necessary.

If the working device does not require two volume streams that can be regulated independently, or if one of the two volume streams that can be regulated independently does not have to be regulated down to very small values, a separately driven fixed-displacement pump can also be combined with a separately driven pump with variable displacement (variable-displacement pump). This combination achieves a better degree of effectiveness at higher volume streams than two variable-displacement pumps. At smaller volume streams, the fixed-displacement pump can work by itself and then also achieves a very high degree of effectiveness. At very small volume streams, the variable-displacement pump can work by itself, which still allows a clearly higher degree of effectiveness than working with two variable-displacement pumps of equal size that are controlled in parallel.

In an embodiment of the invention, a computer unit is provided, which is connected to the control unit and is set up for determining the rotating speed of the first motor and the rotating speed of the second motor, at a predetermined pressure and volume stream or at a predetermined power, at which the best degree of effectiveness is achieved. In this way, efficient operation of the hydraulic main pumps is achieved.

In a further embodiment of the invention, a multi-dimensional characteristic field is stored in the computer unit, from which field the degree of effectiveness is obtained as a function at least of the rotating speed and pressure difference, and on the basis of which the determination of the rotating speeds of the first motor and of the second motor takes place. In this way, energetically optimal control of the rotating speeds of the motors as well as of the displacements to be set is made possible by the computer, by way of the controller, without the operator of the special underground construction device having to do anything.

Preferably, a characteristic field of the first motor and a characteristic field of the second motor are stored in the computer unit, from which fields the degree of effectiveness of the corresponding motor is obtained from the rotating speed and the torque, wherein the determination of the rotating speeds of the first motor and of the second motor takes place using the stored characteristic fields of all the motors. Particularly preferably, the characteristic fields of the hydraulic main pumps are also stored in the computer unit.

For a variable-displacement pump, there is a three-dimensional characteristic field in which the degree of effectiveness results as a function of rotating speed, pressure difference and displacement; in the case of a fixed-displacement pump, this characteristic field is two-dimensional. The characteristic field of the corresponding electric motor, which is determined by the rotating speed and the torque, is superimposed on these characteristic fields. For each combination of pressure and volume stream, an energetically optimal setting with regard to shut-off of a pump, rotating speed or rotating speeds of both pumps or of only one pump, and, if applicable, of the displacements to be set, is obtained in this way.

Because the hydraulic power can be calculated as the product of pressure difference and volume stream, a plurality of combinations of pressure and volume stream can be set for each hydraulic drive power required at the working device, wherein for each volume stream, once again combinations of pump rotating speed and pump displacement are obtained. Furthermore, the number of pumps that generate the pressure and volume stream can be varied by means of shutting off individual pumps. The computer unit is preferably set up in such a manner that it selects the most energetically practical combination from all the possible ones.

In a further development of the invention, sensors for detecting the volume stream and the pressure of at least one hydraulic circuit of a hydraulic main pump and/or sensors for detecting the rotating speed and/or the pressure and/or the displacement of at least one hydraulic main pump are provided, which sensors are connected to the computer unit. In this way, detection of the actual system variables is made possible. By means of a comparison of the determined optimal operating parameters of the pumps and motors with the actual operating variables determined by the sensors, regulation of the pumps and motors by means of the computer unit is made possible.

In an embodiment of the invention, a working device is held by the holder of the support frame, which working device comprises at least one hydraulic motor that is connected to the first hydraulic main pump and/or the second hydraulic main pump by way of lines, wherein sensors are provided for detecting the rotating speed and the displacement of the at least one hydraulic motor or the rotating speed and the displacement of at least one hydraulic main pump, and for detecting pressures ahead of and/or after at least one hydraulic main pump and/or at least one hydraulic motor, which sensors are connected to the computer unit. Optimally, pressures ahead of and after the at least one hydraulic main pump, as well as ahead of and after the at least one hydraulic motor are detected.

In the case of an open hydraulic circuit, at least the pressure after the pump should be detected; in the case of a closed circuit, at least the pressures ahead of and after the pump are required.

In this way, the currently required hydraulic power can be determined by way of the computer unit, which power results from the differential pressure at the hydraulic motors and the volume stream of the pumps, which stream can be determined from the rotating speed and displacements of the pumps, plus the losses in the circuit. The losses in the circuit result from the volume stream and the pressure difference between pump and input pressure at the hydraulic motor as well as the output pressure of the hydraulic motor and the volume stream. The losses, i.e., the power losses in the system can be measured by way of volume streams and pressure losses or can be stored in the computer unit.

In a further embodiment of the invention, at least one hydraulic motor has a variable displacement, wherein the at least one hydraulic motor is connected to a control unit by way of which the rotating speed and the displacement can be set and which is connected to the computer unit. In this way, power-dependent control of the hydraulic motor is made possible at a minimal required volume stream, and thereby the energy efficiency is increased.

The present invention is furthermore based on the task of making available a method for operation of a special underground construction device, in particular a pile-driving or drilling device, which, in particular, allows a higher degree of effectiveness at lower powers called up by a connected working device. This task is accomplished by means of the characteristics according to another aspect of the invention. Because the at least two hydraulic main pumps are each driven by way of an electric motor, wherein the at least two hydraulic main pumps are operated independently of one another, at a different rotating speed, even when the hydraulic oil volume streams produced by them are brought together, a reduction of drag powers is made possible and thereby the energy efficiency of the special underground construction device is increased.

In a further development of the invention, the rotating speed required for an optimal degree of effectiveness of the electric motors and of the hydraulic main pumps driven by them, at which the motors and pumps are operated, is determined for the individual electric motors as a function of a predetermined pressure or a predetermined power, using characteristic line fields. In this way, efficient operation of the electric motors is achieved, and thereby the degree of effectiveness of the special underground construction device is further increased.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows the schematic representation of a German Machine Tool Builders Association (hereinafter “VDW”) drilling system having a telescoping leader support frame;

FIG. 2 shows the schematic representation of the dual-head drilling device of the VDW drilling system from FIG. 1 in partial section;

FIG. 3 shows the schematic representation of the hydraulic circuitry of the motors of the dual-head drilling device from FIG. 2, with two separate oil volume streams;

FIG. 4 shows the schematic representation of the hydraulic circuitry of the hydraulic main pumps of the support frame of the rotary drilling system from FIG. 1;

FIG. 5 shows the schematic representation of the hydraulic circuitry of the hydraulic main pumps of the support frame of a rotary drilling system in a second embodiment;

FIG. 6 shows the schematic representation of the hydraulic circuitry of the hydraulic main pumps of the support frame of a rotary drilling system in a third further embodiment;

FIG. 7 shows the schematic representation of the hydraulic circuitry of the hydraulic main pumps of the support frame of a rotary drilling system in a fourth embodiment;

FIG. 8 shows the schematic representation of a vibrating pile-driving system with its support frame;

FIG. 9 shows the schematic representation of the gear mechanism cell of the vibrating pile-driving device of the vibrating pile-driving system from FIG. 8;

FIG. 10 shows the schematic representation of the hydraulic system of the motors of the vibrating pile-driving device from FIG. 9, having a common oil volume stream;

FIG. 11 shows the schematic representation of the hydraulic circuitry of the main pumps of the support frame of the vibrating pile-driving system from FIG. 8;

FIG. 12 shows the schematic representation of the hydraulic circuitry of the hydraulic main pumps of the support frame of a vibrating pile-driving system in a second embodiment;

FIG. 13 shows the schematic representation of the hydraulic circuitry of the hydraulic main pumps of the support frame of a vibrating pile-driving system in a third further embodiment;

FIG. 14 shows the schematic representation of the hydraulic circuitry of the hydraulic main pumps of the support frame of a vibrating pile-driving system in a fourth embodiment;

FIG. 15 shows the schematic representation of the degree of effectiveness characteristic line field of the hydraulic main pumps of the support frame from FIG. 1 as a function of the differential pressure and rotating speed ratio at a ratio of the set displacement to the maximal displacement of 0.8;

FIG. 16 shows the schematic representation of the degree of effectiveness characteristic line field of the hydraulic main pumps of the support frame from FIG. 1 as a function of the differential pressure and rotating speed ratio at a ratio of the set displacement to the maximal displacement of 0.4; and

FIG. 17 shows the schematic representation of the degree of effectiveness characteristic line field of the electric motors for driving the hydraulic main pumps of the support frame from FIG. 1 as a function of the rotating speed and torque.

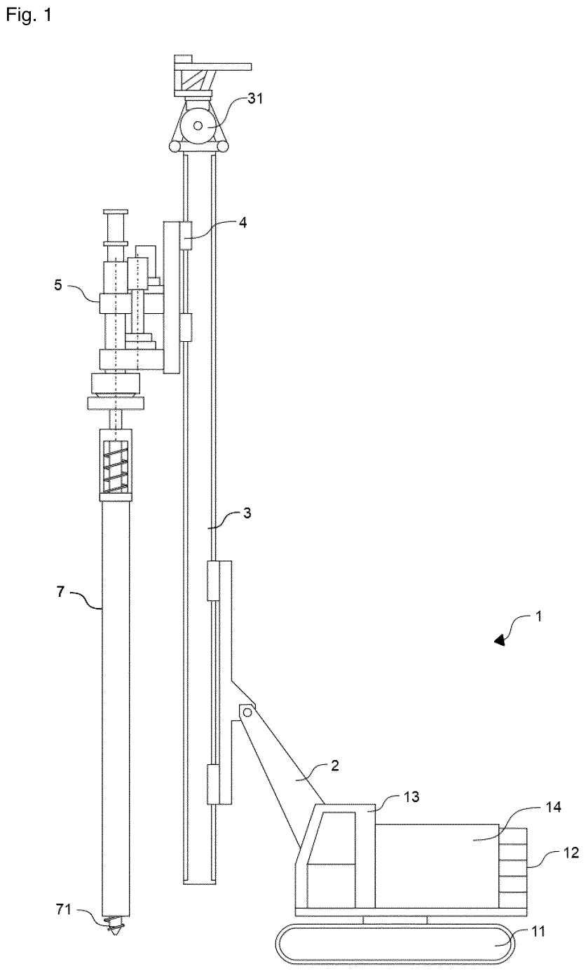

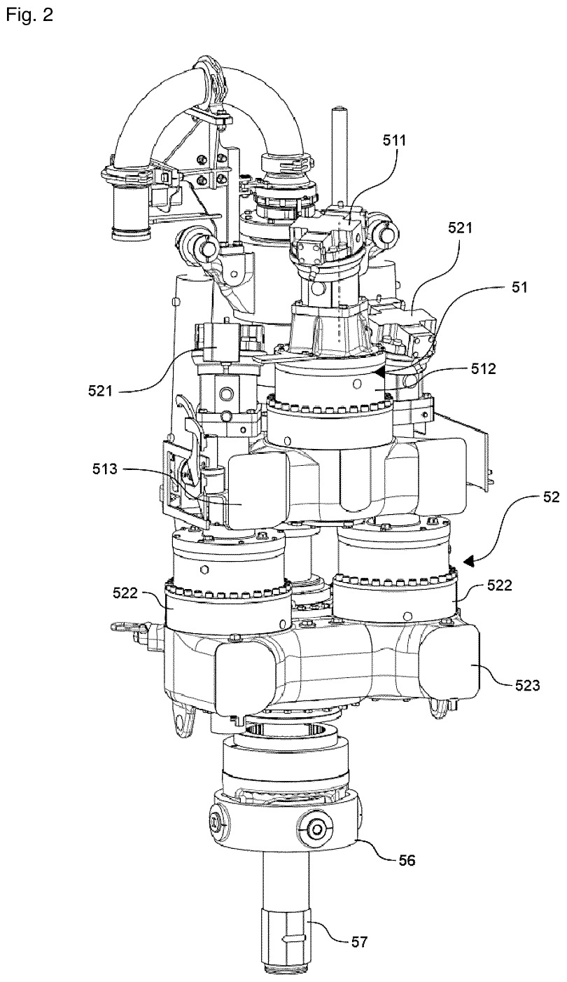

### DETAILED DESCRIPTION OF PREFERRED EMBODIMENTS

The VDW rotary drilling system selected as an exemplary embodiment essentially consists of a support frame 1 that is connected to a leader 3 by way of a kinematic part 2, on which leader a working device carriage 4 is displaceably arranged, which carriage holds a VDW dual-head drilling device 5.

The working device carriage 4 is displaceable along the leader 3, in both directions, by way of hydraulic cylinders arranged in the interior of the leader 3—not shown—and by way of cables that are passed over a deflection roller 31.

The support frame 1 comprises an undercarriage 11 provided with a crawler track unit, on which undercarriage a superstructure 12 is arranged so as to rotate. The superstructure 12 comprises a driver's cabin 13 as well as a machine space 14 that holds a hydraulic unit 6 for the operation of the working device attached to the working device carriage 4, in the present case of the VDW dual-head drilling device 5. Furthermore, a diesel engine for driving a generator that is provided is present in the machine space and connected to a buffer rechargeable battery. The buffer rechargeable battery serves to supply voltage to the electric motors for driving the provided hydraulic main pumps 61, 62 and hydraulic secondary pumps. The drive of the crawler track unit of the undercarriage 11 takes place, in the exemplary embodiment, by way of at least one hydraulic motor that is operated by the hydraulic oil volume streams of the hydraulic main pumps 61, 62. In place of a diesel engine, the generator can also be operated by some other internal combustion engine. Of course, a hydrogen fuel cell can also be provided to supply the buffer rechargeable battery with a charging current.

In the exemplary embodiment, a secondary hydraulic unit—not shown—is furthermore present to supply secondary assemblies of the support frame 1 as well as, if applicable, secondary assemblies of a working device held by the working device carriage 4. For this purpose, the secondary hydraulic unit comprises a hydraulic secondary pump—not shown—, which is connected to an electric motor, by way of which it is operated. Further hydraulic secondary pumps can also be provided, which are operated by way of individual electric motors or also by way of a common electric motor.

The hydraulic unit 6 comprises, in the exemplary embodiment, a first hydraulic main pump 61 configured as a fixed-displacement pump, which is operated using a first electric motor 611, and a second hydraulic main pump 62, also configured as a fixed-displacement pump, which is operated using a second electric motor 612. The inlets of the two hydraulic main pumps 61, 62 are connected, by way of access lines 63, to a hydraulic tank 69, by way of which they are supplied with hydraulic oil. On the outlet side, the hydraulic main pumps 61, 62 are connected, by way of outlet lines 64, 65, to hydraulic jacks of a hydraulic coupling block—not shown—arranged on the working device carriage 4. The hydraulic coupling block—not shown—serves for connecting the hydraulic lines of a working device (inflow and return flow lines) held by the working device carriage to the hydraulic lines of the hydraulic unit 6 of the support frame 1 (outlet and return flow lines).

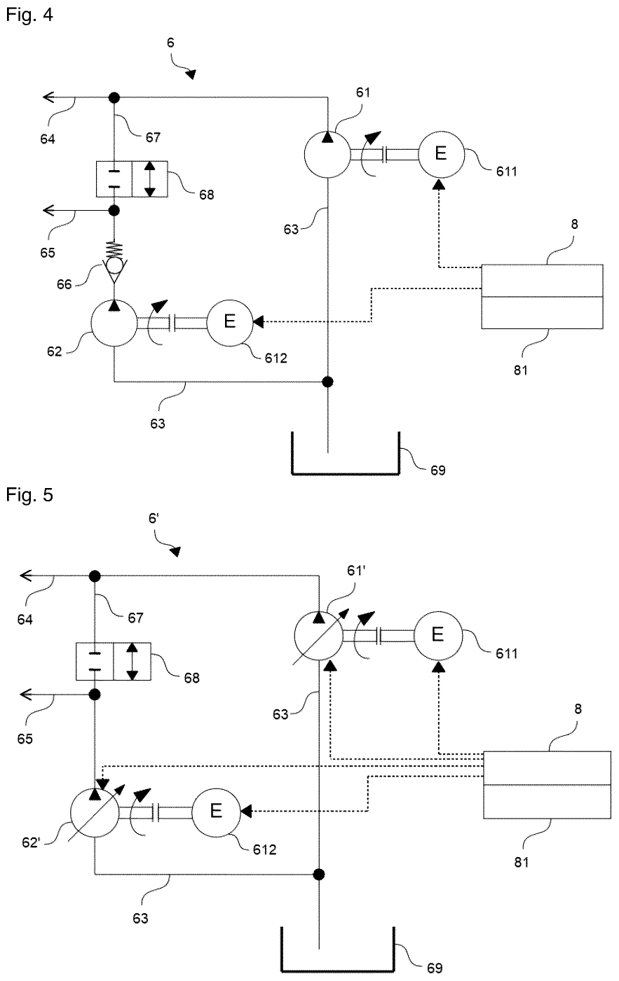

In the exemplary embodiment, a kick-back valve 66 is arranged behind the second hydraulic main pump 62, on the outlet side. Furthermore, the outlet lines 64, 65 between the two hydraulic main pumps 61, 62 and the hydraulic coupling block—not shown—are connected to one another by way of a connection line 67, in which a 2/2-way valve 68 is arranged (see FIG. 4). The 2/2-way valve 68 is set in such a manner that the connection line 67 is interrupted. In this position, two independent volume streams are produced by the pumps 61, 62, by way of the two outlet lines 64, 65.

The hydraulic main pumps 61, 62 are connected to a control unit 8, by way of which they are controlled. The controller of the control unit 8 is designed for achieving an optimal degree of effectiveness at a predetermined oil volume stream and a predetermined pressure, or at a predetermined power for pressure and volume stream. For this purpose, the control unit 8 is connected to a computer unit 81, in which characteristic fields for the two hydraulic main pumps 61, 62 are stored, which are superimposed by the characteristic field of the assigned electric motor 611, 612, which fields are also stored. In the case of the present hydraulic unit 6, the degree of effectiveness results, in the two-dimensional characteristic field of the two hydraulic main pumps 61, 62 configured as a fixed-displacement pump, as a function of rotating speed and pressure difference. The characteristic fields of the electric motors 611, 612 are determined by rotating speed and torque. For every combination of pressure and volume stream, an energetically optimal setting results in this way, with regard to the rotating speeds of the two pumps (with shut-off, if applicable, of the hydraulic main pump 62 (rotating speed equal to zero), and switching of the 2/2-way valve 68 to “pass-through”). When the hydraulic main pump 62 is shut off, the kick-back valve 66 prevents the hydraulic main pump 62 from being rotated in reverse.

The computer unit 81 is furthermore connected to sensors—not shown—for detecting the pivot angle, the rotating speed, as well as the pressure of the hydraulic main pumps 61, 62. In place of the sensors for detecting the pivot angle, the volume stream can also be recorded and the pivot angle can be determined from volume stream and rotating speed. The volume stream can also be calculated from displacement and rotating speed of the hydraulic motors (511, 521, 93) of the working device held by the working device carriage 4. Direct recording of displacement and rotating speed by way of a sensor system is most precise.

The VDW dual-head drilling device 5 comprises two coaxially arranged rotary drives 51, 52, which are individually driven hydraulically and can be operated in opposite directions of rotation while drilling. The first rotary drive 51 comprises a first hydraulic motor 511, which is connected to a first planetary gear 512. The first planetary gear 512 drives a first spur gear 513, which is connected to a drill screw holder 57. The second rotary drive 52 comprises two second hydraulic motors 521, switched in parallel, which are connected to a second planetary gear 522, in each instance. The two second planetary gears 522 drive a second spur gear 523, which is connected to a drill pipe holder 56 that encloses the drill screw holder 57.

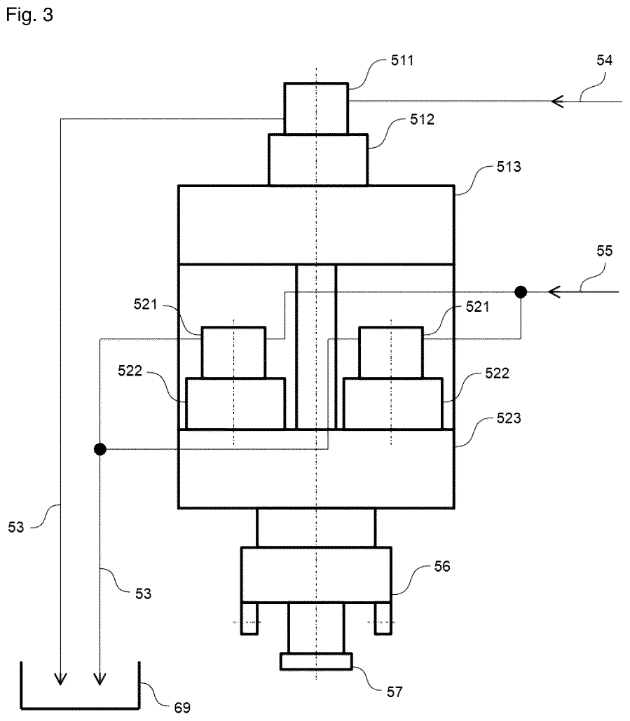

The hydraulic motors 511, 521 of a rotary drive 51, 52, in each instance, are connected, by way of an inflow line 54, 55, in each instance, to an outlet line 64, 65, in each instance, of the hydraulic unit 6. For this purpose, the inflow lines 54, 55 are connected to the assigned hydraulic jacks of the hydraulic coupling block—not shown—arranged on the working device carriage 4 of the leader 3 of the support frame 1. The first hydraulic motor 511 is thereby supplied with the volume stream of the first hydraulic main pump 61, while the two second hydraulic motors 521, which are switched in parallel, are supplied with the volume stream of the second hydraulic main pump 62, which is divided up between them. On the outlet side, the hydraulic motors 511, 521 are connected to the hydraulic tank 69 of the support frame 1 by way of return flow lines 53, which are also passed by way of the coupling block—not shown—(see FIG. 3).

The VDW dual-head drilling device 5 is provided for the purpose of driving a drill pipe 7 and a screw 71 situated in it independently of one another, at different torques, different speeds, and also a different direction of rotation. The screw 71 is rotated with the power take-off of the upper, first rotary drive 51, while the drill pipe 7 is rotated with the lower, second rotary drive 52.

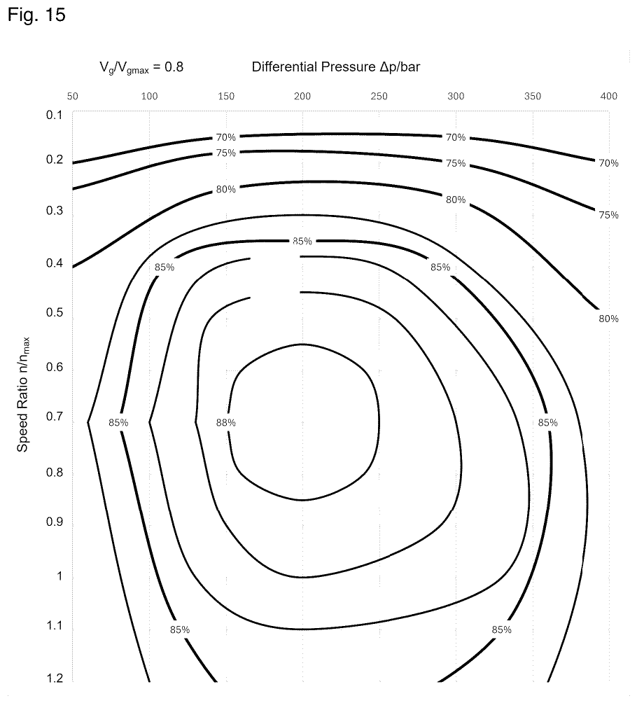

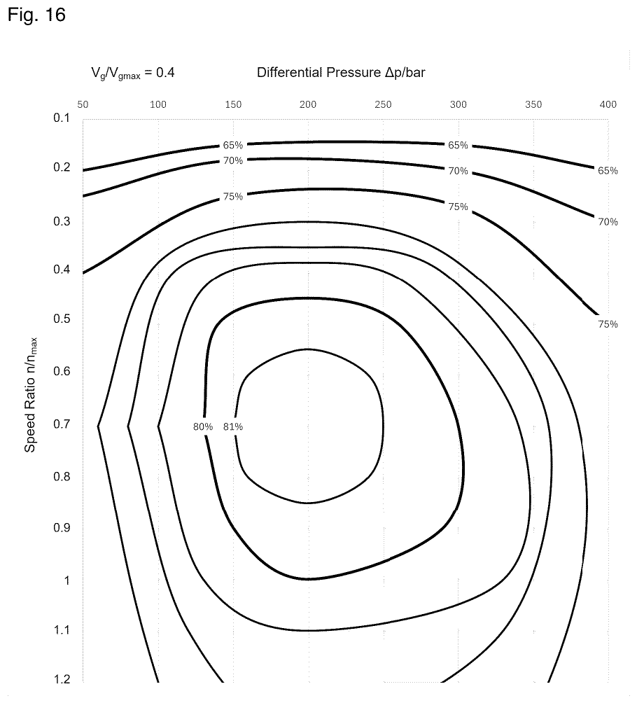

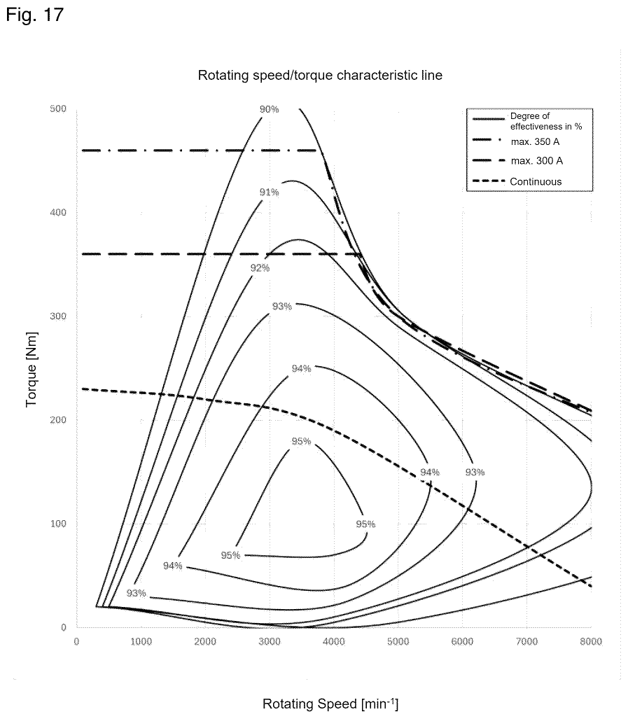

In FIG. 5, a further embodiment of the hydraulic unit 6′ of the support frame 1 of the above VDW rotary drilling system is shown. In this regard, the two hydraulic main pumps 61′, 62′ are configured as variable-displacement pumps having a variable displacement, and are connected to the control unit 8. For these variable-displacement pumps, a three-dimensional characteristic field is stored in the computer unit 81, in which field the degree of effectiveness occurs as a function of rotating speed, pressure difference, and displacement (see FIGS. 15 and 16). These characteristic fields are, in turn, superimposed by the characteristic field of the corresponding electric motor 611, 612 (see FIG. 17: the solid lines show the degree of effectiveness in a contour chart. The other characteristic lines show upper limits for 350 A, 300 A and thermally possible constant load). For each combination of pressure and volume stream, an energetically optimal setting with regard to the rotating speeds as well as the displacements to be set, of both hydraulic main pumps 61′, 62′ arises here (once again with shutting off the hydraulic main pump 61′, if applicable, and adjusting the 2/2-way valve 68). Here, a kick-back valve is not necessary, due to the possibility of adjusting the displacement to zero.

This embodiment of the hydraulic unit 6′ allows setting the two volume streams by way of the pump rotating speed and/or displacement. For working devices that are used, which require only one volume stream for operation, such as vibrating pile-driving devices, it is possible to pivot one of the hydraulic main pumps 61′, 62′ to displacement zero for small volume streams when adjusting the 2/2-way valve 68 to “pass-through.” In this way, very small volume streams can be implemented.

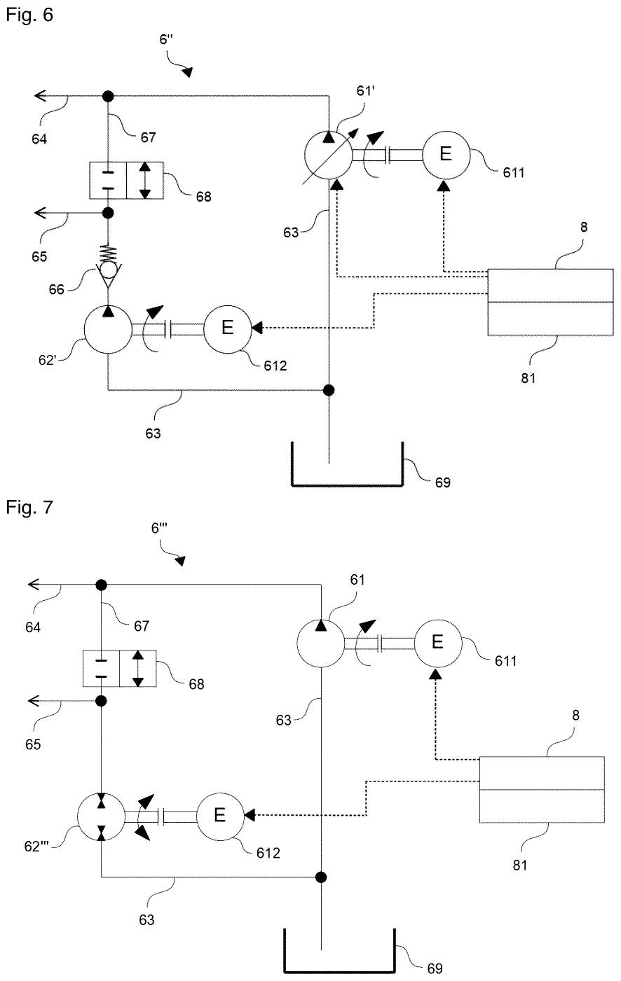

In FIG. 6, a third embodiment of the hydraulic unit 6″ of the support frame 1 is shown. The hydraulic unit 6″ essentially corresponds to the hydraulic unit 6 according to the first exemplary embodiment, wherein the first hydraulic main pump 61′ is configured as a variable-displacement pump. This embodiment proves to be slightly more efficient, in the case of large volume streams, than the variant according to FIG. 5, and offers the possibility, when using a vibrating pile-driving device 9 as the working device, of implementing very small volume streams when combining the two hydraulic main pumps 61′, 62′ into a common hydraulic circuit.

In FIG. 7, a fourth embodiment of the hydraulic unit 6″ of the support frame 1 is shown. The hydraulic unit 6′″ essentially corresponds to the hydraulic unit 6 according to the first exemplary embodiment, wherein the second hydraulic main pump 62″ is configured as a fixed-displacement pump that conveys in both directions. A kick-back valve is not necessary here. In contrast to the first exemplary embodiment according to FIG. 4, very small volume streams can be implemented, in that the second hydraulic main pump 62″ conveys in reverse. A disadvantage here is a relatively poor degree of effectiveness, however, because both hydraulic main pumps 61, 62″ and both electric motors 611, 612 are running (the second electric motor 612 runs in generator operation, in this regard) and cause losses that can be high with reference to the volume stream. This embodiment is particularly suitable for working devices that need only one volume stream for operation, such as vibrating pile-driving devices.

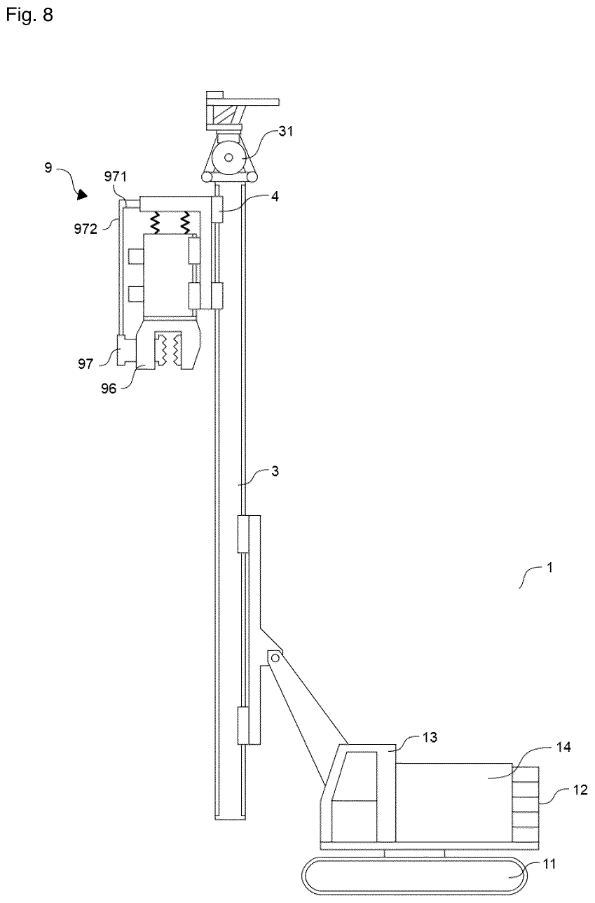

The vibrating pile-driving system selected as a further exemplary embodiment, according to FIG. 8, essentially consists of the support frame 1 of the VDW rotary drilling system described above, the working device carriage 4 of which holds a vibrating pile-driving device 9 here, instead of the dual-head drilling device.

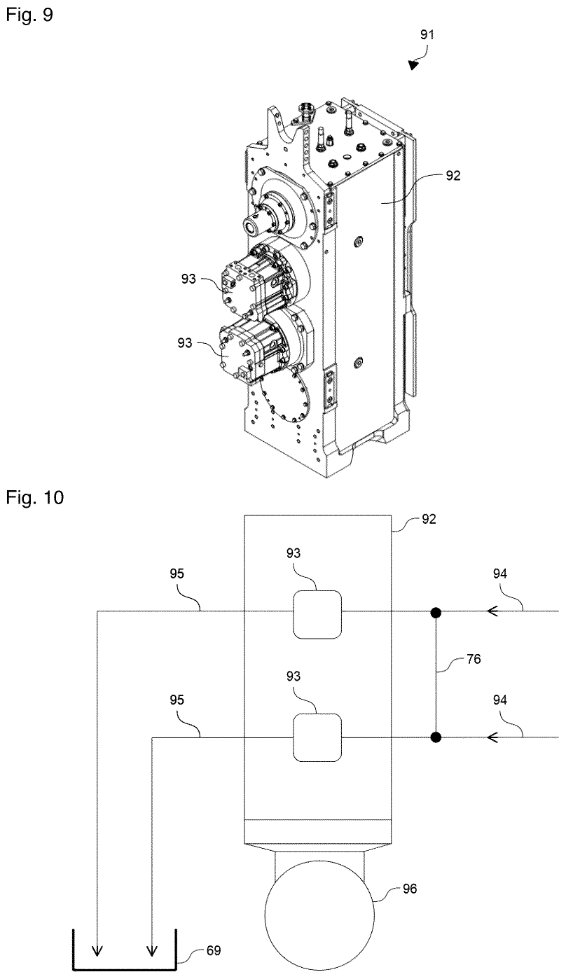

The vibrating pile-driving device 9 comprises an oscillator 91, which is shown in FIG. 9. The oscillator 91 comprises a housing 92, in which an oscillator gear mechanism is arranged in a known manner, as it is described, for example, in EP 1 976 292 B1 or also EP 2 085 149 B1. The oscillator gear mechanism—not shown—comprises three shafts, in the exemplary embodiment, which are provided with imbalances, of which two shafts are conducted out of the housing 92 and connected, in each instance, to a hydraulic motor 93, by way of which they are driven. Clamping tongs 96 are arranged on the housing 32 in a known manner, to hold a pile element, for example a sheet pile. The clamping tongs 96 have a hydraulic cylinder 97, by way of which their jaws can be displaced relative to one another. The hydraulic cylinder 97 is connected to the secondary hydraulic unit—not shown—of the support frame 1 by way of an inflow line 971 and a return flow line 972, by way of the hydraulic coupling block—not shown—that is arranged on the working device carriage 4 of the support frame 1.

The two hydraulic motors 93 of the oscillator 91 are coupled mechanically and hydraulically, and are supplied with a volume stream by the hydraulic unit 6. By means of the connection of the outlet lines 64, 65 by means of the connection line 76, it is ensured that the volume stream is divided up onto the two inflow lines 94 of the oscillator 91 in such a manner that a minimum of pressure losses occurs. Usually, at an identical embodiment of the inflow lines 94, the identical partial volume stream flows in the lines (as long as both hydraulic motors 93 have the same displacement, and drive imbalance shafts having the identical translation).

A connection of the two inflow lines, as it is present in the case of this exemplary embodiment, is particularly practical when the two hydraulic motors 93 (it is also possible for more than two hydraulic motors to be provided) work at different displacements, for example as differently sized fixed-displacement motors, if the hydraulic motors drive the imbalances of the oscillator gear mechanism—not shown—at different translations, or also if fixed-displacement and variable-displacement motors are combined. Then the connection between the forward flow lines serves to adapt the volume streams in the individual inflow lines 94 and to ensure the lowest possible flow losses.

In FIG. 10, the hydraulic system of the hydraulic motors 93 is shown. The hydraulic motors 93 are connected to the outlet lines 64, 65 of the hydraulic unit 6 of the support frame by way of two inflow lines 94 that are connected to one another. For this purpose, the inflow lines 94 are connected to the assigned hydraulic jacks of the hydraulic coupling block—not shown—arranged on the working device carriage 4 of the leader 3 of the support frame 1. The 2/2-way valve 68 of the hydraulic unit 6 of the support frame 1 is set to “pass-through.” By means of the return flow lines 95, the hydraulic oil is conducted back into the hydraulic tank 69 by way of the hydraulic coupling block—not shown—arranged on the working device carriage 4 of the support frame 1.

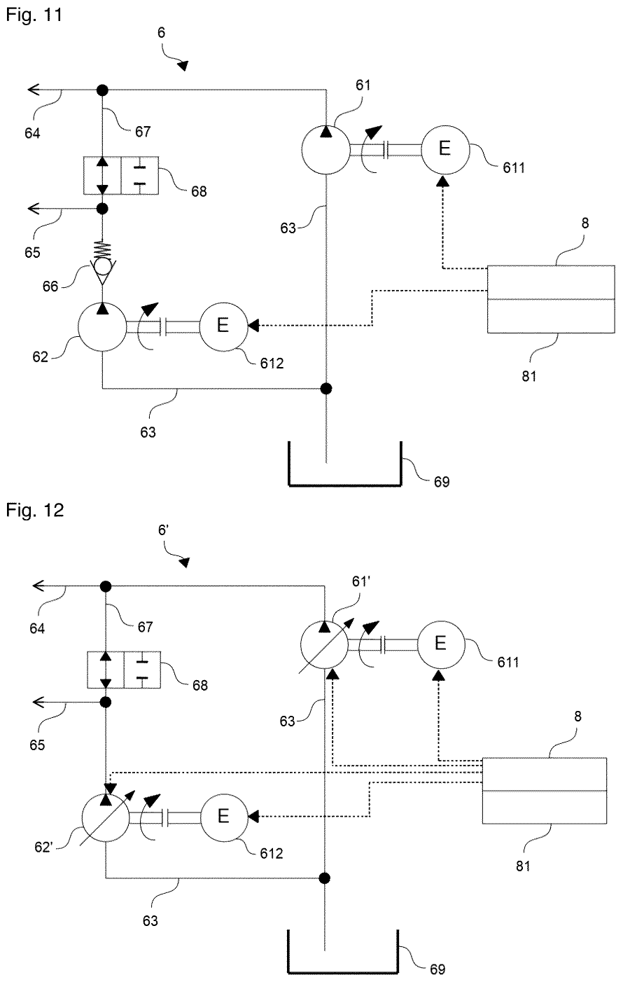

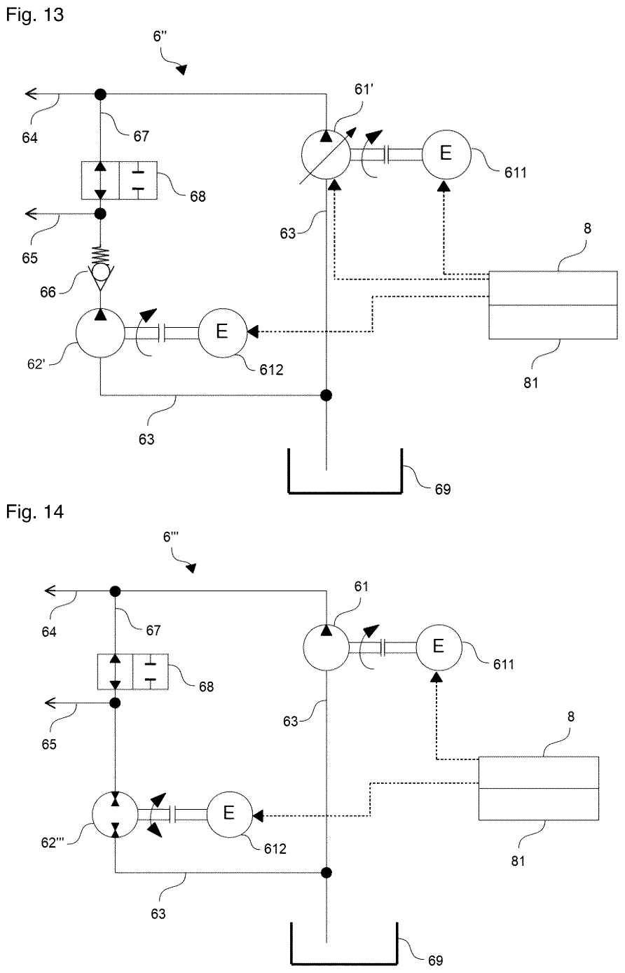

In the case of the vibrating pile-driving system, the support frame 1 can be provided, as described above in connection with the VDW rotary drilling system, with different embodiments of the hydraulic unit 6. In the case of the present use of this support frame 1, for use with a vibrating pile-driver 9, the hydraulic unit 6 is put into pile-driving operation in the case of all the embodiments, wherein the 2/2-way valve 68 is set in the “pass-through position,” and thereby the two outlet lines 64, 65 are coupled by way of the connection line 67. The different embodiments of the hydraulic unit 6 during pile-driving operation are shown in FIGS. 11 to 14.

Although only a few embodiments of the present invention have been shown and described, it is to be understood that many changes and modifications may be made thereunto without departing from the spirit and scope of the invention.

What is claimed is:

1. A special underground construction device comprising:
a support frame (1);
a holder for a hydraulic working device arranged on the support frame; and
first and second hydraulic main pumps (61, 62) for making available at least one hydraulic oil volume stream for operation of a held working device;
wherein the first and second hydraulic main pumps are connected, by way of lines (63, 64, 65), to the holder;
wherein the first hydraulic main pump (61) is driven by a first motor connected to the first hydraulic main pump, and the second hydraulic main pump (62) is driven by a second motor separate from the first motor and connected to the second hydraulic main pump.

2. The special underground construction device according to claim 1, wherein the first and second hydraulic main pumps provide first and second hydraulic oil volume stream and the support frame (1) has a chassis that is driven by at least one of the first and second hydraulic motors, which is supplied with the first and second hydraulic oil volume streams of the first and second hydraulic main pumps (61, 62).

3. The special underground construction device according to claim 1, further comprising at least one hydraulic secondary pump to make available at least one secondary hydraulic oil volume stream for operation of secondary assemblies.

4. The special underground construction device according to claim 1, wherein the support frame (1) has a leader (3) on which a working device carriage (4) is displaceably arranged, wherein the working device carriage has the holder for the hydraulic working device.

5. The special underground construction device according to claim 1, wherein at least one of the first hydraulic main pump (61) and the second hydraulic main pump (62) is configured as a fixed-displacement pump having a pump outlet provided with a kick-back valve (66).

6. The special underground construction device according to claim 1, wherein at least one of the first hydraulic main pump (61) and the second hydraulic main pump (62) has a variable displacement.

7. The special underground construction device according to claim 1, further comprising a control unit (8) connected to the first motor and the second motor for controlling the first motor and the second motor independently of one another, wherein at least one of the first motor and the second motor is formed by an electric motor (611, 621).

8. The special underground construction device according to claim 3, wherein the at least one secondary hydraulic pump is driven by way of a third motor separate from the first and second motors and formed by an electric motor.

9. The special underground construction device according to claim 8, wherein multiple secondary hydraulic pumps are provided and brought together into at least first and second groups, wherein at least the first group is driven by way of the third motor.

10. The special underground construction device according to claim 7, further comprising a computer unit (81) connected to the control unit (8) and configured for determining a first rotating speed of the first motor and a second rotating speed of the second motor achieving an optimal degree of effectiveness at a predetermined pressure and volume stream or at a predetermined power.

11. The special underground construction device according to claim 10, wherein an at least one two-dimensional or three-dimensional characteristic field is stored in the computer unit (81), wherein the optimal degree of effectiveness is obtained from the at least one two-dimensional or three-dimensional characteristic field as a function at least of rotating speed and pressure difference, wherein the at least one two-dimensional or three-dimensional characteristic field is used to determine the first and second rotating speeds of the first motor and of the second motor achieving the optimal degree of effectiveness.

12. The special underground construction device according to claim 11, wherein a first characteristic field of the first motor and a second characteristic field of the second motor is stored in the computer unit (81), wherein the optimal degree of effectiveness results from the first rotating speed and torque of the first motor and the second rotating speed and torque of the second motor, wherein the determination of the first rotating speed of the first motor and of the second rotating speed of the second motor takes place using the stored first and second characteristic fields.

13. The special underground construction device according to claim 10, further comprising
sensors for detecting the volume stream and the pressure of at least one hydraulic circuit of the first hydraulic main pump; and/or
sensors for detecting the first rotating speed and/or a pressure and/or a displacement of the first hydraulic main pump;
wherein the sensors are connected to the computer unit (81).

14. The special underground construction device according to claim 10,
wherein the working device is held by the holder arranged on the support frame (1),
wherein the working device comprises at least one hydraulic motor (511, 521, 93) connected, by way of lines (53, 54, 55, 94, 95), to the first hydraulic main pump (61) and/or the second hydraulic main pump (62),
wherein sensors connected to the computer unit (81) are provided for detecting rotating speed and displacement of the at least one hydraulic motor (511, 521, 93) or rotating speed and displacement of the first or second hydraulic main pump (61, 62) and for detecting pressures before and/or after the first or second hydraulic main pump (61, 62) and/or before and/or after the at least one hydraulic motor (511, 521, 93).

15. The special underground construction device according to claim 14, wherein the at least one hydraulic motor (511, 521, 93) has a variable displacement, wherein the at least one hydraulic motor (511, 521, 93) is connected to the control unit (8) for setting the rotating speed and the displacement, and wherein the control unit is connected to the computer unit (81).

16. A method for operation of the special underground construction device according to claim 1, the method comprising:
supplying the hydraulic working device with hydraulic oil by way of the first and second hydraulic main pumps (61, 62); and
driving the first and second hydraulic main pumps (61, 62) by way of the first and second motors, respectively, wherein the first and second motors comprise electric motors (611, 621);
wherein the first and second hydraulic main pumps (61, 62) are operated independently of one another, at different rotating speeds, to produce first and second hydraulic oil volume streams, respectively, even where the first and second hydraulic oil volume streams are brought together.

17. The method according to claim 16, further comprising determining a required rotating speed for an optimal degree of effectiveness of the first and second motors (611, 621) and of the first and second hydraulic main pumps (61, 62) driven by the first and second motors, for each of the first and second motors (611, 621) as a function of a predetermined pressure or a predetermined power, using characteristic line fields.
